(19) United States
(12) Patent Application Publication
(10) Pub. No.: US 2002/0007487 A1
(43) Pub. Date: Jan. 17, 2002

(54) Image processing apparatus using operation menu

(76) Inventors: Yuichi Matsumoto, Kanagawa (JP); Masaki Kutsuna, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/873,250

(22) Filed: Jun. 5, 2001

(30) Foreign Application Priority Data
Jun. 8, 2000 (JP) 2000-171573

(51) Int. Cl. G06F 3/00

(52) U.S. Cl. 725/37

(57) ABSTRACT

A controller displays on a display unit an image corresponding to an input image signal and an operation menu having a plurality of menu portions at different hierarchical levels each including one or more menu items, the operation menu relating to processing of the image signal. An operating unit is provided which includes selecting keys for selecting one of the items in the operation menu displayed on the display unit, and which includes a plurality of function keys. A function corresponding to one of the items in the operation menu selected by the operating unit is assigned to one of the plurality of function keys. In response to the operation of the function key, the processing relating to the image signal is controlled so as to execute the function assigned to the function key.

### BACKGROUND OF THE INVENTION

1. Field of the Invention

The present invention relates to an image processing apparatus and, more particularly, to an apparatus which displays a multilevel hierarchical operation menu, and which controls processing relating to an image signal according to a selected item in the operation menu.

2. Related Background Art

Television receivers, video monitors, etc., are known as apparatuses capable of processing image signals and displaying them. As means for enabling a user to adjust and change image and sound qualities in such an apparatus, e.g., a television receiver, a method of using a pull-down menu and a method of using a pop-up menu are conceivable.

FIG. 14 shows an example of a menu display on the screen.

There are adjustment/change subjects: “CHANNEL”, “INPUT SOURCE”, “FUNCTION”, “IMAGE QUALITY”, and “SOUND QUALITY”. With respect to each adjustment/change subject, at least one parameter is set at a lower hierarchical level. In the example shown in FIG. 14, if “IMAGE QUALITY” is selected at the first hierarchical level, one of “BRIGHTNESS”, “CONTRAST”, “COLOR DEPTH”, and “BLACK LEVEL” can be selected at the second hierarchical level, the direction of adjustment (plus or minus direction) can be selected at the third hierarchical level, and the amount of adjustment can be selected at the fourth hierarchical level.

For selection of items at each hierarchical level, downward and upward selection keys, channel-up and channel-down keys or the like of an operation remote controller, etc. are used. For a move from one hierarchical level to another, a specially-prepared key or a key operation is used. For example, when “CONTRAST” is selected at the second hierarchical level, a determination key is operated to display a menu at the lower hierarchical level subordinate to that of “CONTRAST”. When one of items in the displayed menu is selected, the determination key is operated to display a menu at a further lower hierarchical level.

Such an operation is repeated to select, for example, “CONTRAST”, “MINUS” and “10 EXEC” and the determination operation is then performed to change the contrast value to a value obtained by subtracting 10 from the present set value.

In recent years, however, the above-mentioned kinds of apparatuses have been generally designed as multifunctional apparatuses such that the number of hierarchical levels and the number of alternatives at each level are increased. Under these circumstances, the conventional menu display methods require a process in which a user must perform many key operations to obtain a certain operation result.

A method of assigning a function probable to be used frequently by a user to one or a small number of keys achieves a certain effect of reducing such an inconvenience. However, functions frequently used by different users vary and this method assigns a number of functions to a number of operating keys to satisfy various user's demands. As a result, this method requires an increased number of operating keys, increases the manufacturing cost of the apparatus and makes it difficult for a user to search for an operating key corresponding to an operation which the user wishes to perform.

A method for enabling a user to freely assign any desired operations to a particular operating key is also effective in simplifying a necessary operating process. Assignment of desired operations to a particular operating key, however, necessitates a complicated key operating process for selecting desired items at desired hierarchical levels from a number of hierarchical menu levels and a number of menu items. The same can also be said with respect to the process of changing operations assigned to a particular operating key.

### SUMMARY OF THE INVENTION

In view of the above-described problems of the conventional art, an object of the present invention is to provide an image processing apparatus capable of assigning a desired function to a particular operating key by a simpler operating process.

Another object of the present invention is to attain assigning the desired functions to the particular operating key by a simpler operation.

To attain these objects, according to an aspect of the present invention, there is presented an image processing apparatus comprising image input means for inputting an image signal relating to a television broadcast; menu generation means for generating a menu image signal representing an operation menu relating to processing of the image signal and having a plurality of menu portions at different hierarchical levels each including at least one menu item; display control means for displaying on a display unit an image relating to the image signal output from the image input means and the operation menu relating to the menu image signal generated by the menu generation means; instruction input means for receiving an instruction from an operating unit including a plurality of function keys and selection means for selecting a desired item in the operation menu displayed on the display; assignment means for assigning, according to a predetermined operation by the operating unit, a function according to one item selected by the selection means from the items in the operation menu displayed on the display unit to one of the plurality of function keys; and control means for controlling, in response to the operation of the function key, the image input means to execute processing corresponding to the function assigned to the function key by the assignment means.

These and other objects and features of the present invention will become apparent from the following detailed description of a preferred embodiment of the invention in conjunction with the accompanying drawings.

### BRIEF DESCRIPTION OF THE DRAWINGS

FIG. 1 is a block diagram schematically showing a configuration of a television receiver to which the present invention is applied;

FIG. 2 is a diagram showing an example of an operation menu portion at a first hierarchical level;

FIG. 3 is a diagram showing an example of a menu portion at a second hierarchical level;

FIG. 4 is a diagram showing an example of a menu portion at a third hierarchical level;

FIG. 5 is a diagram showing an example of a menu portion at a fourth hierarchical level;

FIG. 6 is a diagram showing an example of a registration menu;

FIG. 7 is a plan view of a remote controller shown in FIG. 1;

FIG. 8 is a diagram showing an example of a display on a screen when a fourth item at the first hierarchical level is selected;

FIG. 9 is a diagram showing an example of a display on the screen when selection through the first to fourth hierarchical levels is completed;

FIG. 10 is a diagram showing an example of a display on the screen including a registration menu;

FIG. 11 is a diagram showing an example of a display on the screen when a third item in the registration menu is selected;

FIG. 12 is a diagram showing an example of a display on the screen including a transparent registration menu;

FIG. 13 is a diagram showing another example of a display on the screen including a registration menu; and

FIG. 14 is a diagram showing an example of a display on the screen including an operation menu.

### DETAILED DESCRIPTION OF THE PREFERRED EMBODIMENTS

An embodiment of the present invention will be described in detail with reference to the accompanying drawings.

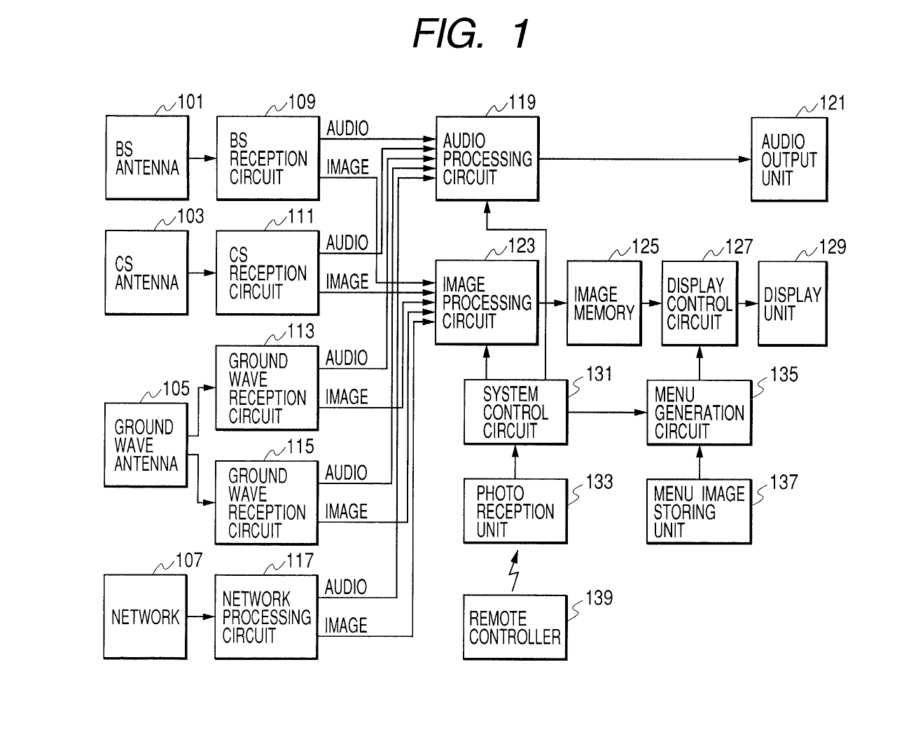

FIG. 1 is a block diagram schematically showing the configuration of a television receiver 100 to which the present invention is applied.

Referring to FIG. 1, a BS (broadcasting by satellite) antenna 101, a CS (communication satellite) antenna 103, a ground wave antenna 105 and an Internet 107 are provided.

A BS reception circuit 109 is constituted by a tuner which detects digital data by demodulating an output from the BS antenna 101 and performs error correcting processing, and which thereby generates an MPEG (Moving Picture Experts Group)-2 transport stream (TS) data, a demultiplexer which extracts image data and audio data in a selected channel from image and audio data in a plurality of channels time-division multiplexed in TS data, a video decoder for decoding separated image data, and an audio decoder for decoding separated audio data.

A CS reception circuit 111 has basically the same configuration as the BS reception circuit.

Each of ground wave reception circuits 113 and 115 includes a well-known tuner which receives and processes an input ground wave broadcast signal, such as an NTSC signal or a PAL signal, supplied from the ground wave antenna 105. Each ground wave reception circuit also includes an analog to digital (A/D) converter for converting a received broadcast signal to a digital signal and a phase locked loop (PLL) for generating a sampling timing signal used by the A/D converter. The ground wave reception circuits 113 and 115 can respectively receive independent channels.

A network processing circuit 117 processes input image and audio information supplied from the data network 107, which is a telephone circuit, a local area network (LAN), the Internet, or the like.

An audio processing circuit 119 selects one of audio signals output from the BS reception circuit 109, the CS reception circuit 111, the ground wave reception circuits 113 and 115 and the network processing circuit 117 according to a control signal from a system control circuit 131. The audio processing circuit 119 supplies the selected audio signal to an audio output unit 121 and changes the volume and sound quality of the selected audio signal. The audio output unit 121 is constituted by a digital to analog (D/A) converter for converting the audio signal from the audio processing circuit 119 into an analog signal, and a speaker for outputting the analog audio signal.

An image processing circuit 123 selects at least one of image signals output from the BS reception circuit 109, the CS reception circuit 111, the ground wave reception circuits 113 and 115 and the network processing circuit 117 according to a control signal from the system control circuit 131. The image processing circuit 123 processes the selected image signal to effect enlargement or reduction to a designated size, to change the frame rate and to obtain an image quality adjustment effect as described below, and writes the processed signal to an image memory 125.

A reference numeral 139 denotes infrared remote controller. A photo-reception unit 133 receives an infrared remote control signal output from the infrared remote controller 139. The system control circuit 131 controls the audio processing circuit 119 and the image processing circuit 123 according to an output from the photo-reception unit 133, i.e., a remote controller 139 operation performed by a user. The system control circuit 131 also controls a menu generation circuit 135 to display on a screen an operation menu described below.

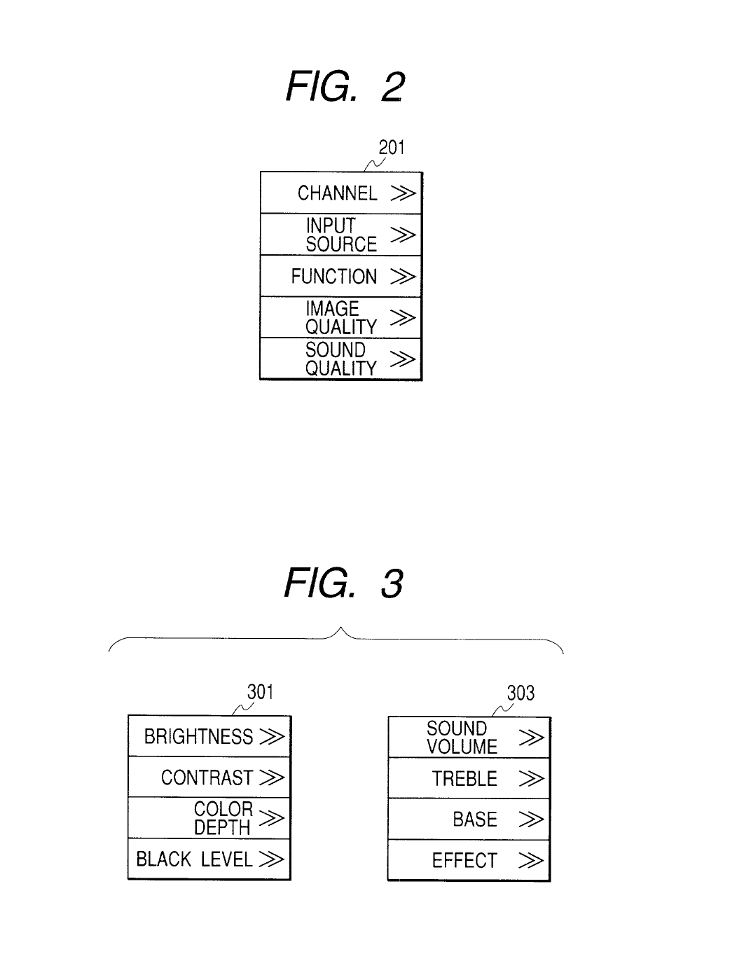

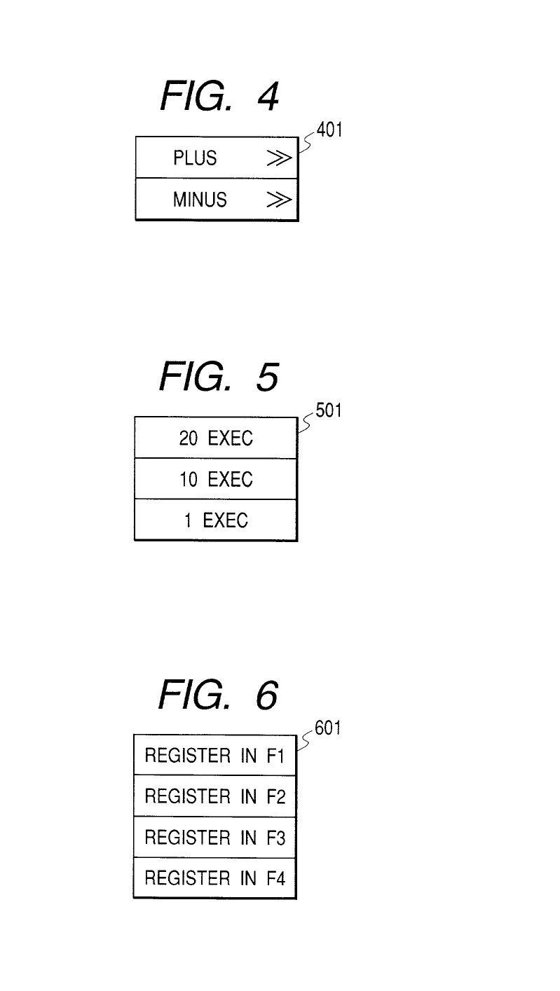

A menu image storing unit 137 stores images representing portions of a menu at different hierarchical levels, such as shown in FIGS. 2 through 6. FIG. 2 shows an image representing a menu portion at a first hierarchical level. A section 301 in FIG. 3 shows an image representing a menu portion at a second hierarchical level with respect to the fourth item (image quality) at the first hierarchical level, and a section 303 shows an image representing a menu portion at the second hierarchical level with respect to the fifth item (sound quality) at the first hierarchical level. FIG. 4 shows an example of an image representing a menu portion at a third hierarchical level for inputting an instruction for an up- or down-operation with respect to each item in the menu image shown in FIG. 3. FIG. 5 shows an example of an image representing a menu portion at a fourth hierarchical level for designation of the amount of change in each item at the third hierarchical level. In this embodiment, the fourth hierarchical level is the lowest hierarchical level. FIG. 6 shows an image representing a registration menu for designation of a function registration with each of function keys of the remote controller 139 described below.

The menu generation circuit 135 forms menu image data according to an instruction from the system control circuit 131 by referring to the menu image storing section 137, and outputs the menu image data to a display control circuit 127. The display control circuit 127 reads out the image signal stored in the image memory 125, superimposes, on this image signal, menu image data from the menu generation circuit 135, and outputs the image signal thereby formed to a display unit 129. The display unit 129 displays the image based on the image signal from the display control circuit 127.

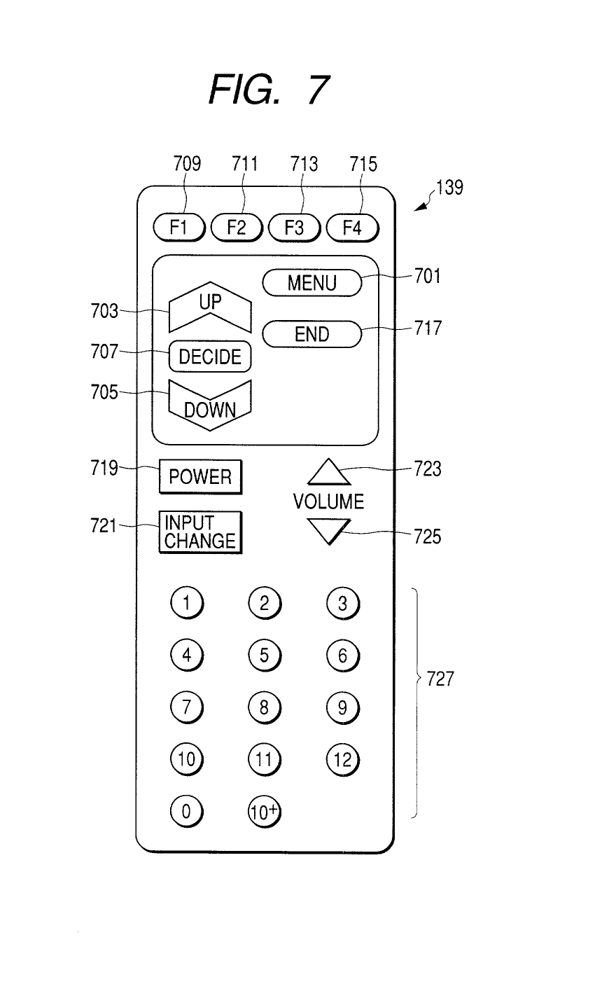

FIG. 7 illustrates the remote controller 139.

Referring to FIG. 7, the remote controller 139 has a menu key 701 for inputting an instruction for display of a menu, an upward movement key 703 for inputting an instruction for an upward movement of a cursor, a downward movement key 705 for inputting an instruction for a downward movement of the cursor, a determination key 707 for inputting an instruction for determination and execution of a selection from menu items, function keys 709, 711, 713, and 715 with each of which a desired function can be registered, and an end key 717 for inputting an instruction for dismissing a menu. The remote controller 139 also has a power key 719 for inputting an instruction for turning on or off the power for the television receiver 100, an input change key 721 for changing images obtained by the BS reception circuit 109, the CS reception circuit 111, the ground wave reception circuits 113 and 115 and the network processing circuit 117 to be displayed by the display unit 129, keys 723 and 725 for changing the sound volume, and a channel key 727 for designating a channel.

The operation of this embodiment will now be described.

The system control circuit 131 controls the audio processing circuit 119 and the image processing circuit 123 according to an input change key 721 operation in the remote controller 139 performed by a user. The audio processing circuit 119 selects one of audio signals output from the BS reception circuit 109, the CS reception circuit 111, the ground wave reception circuits 113 and 115 and the network processing circuit 117 according to an instruction from the system control circuit 131, and outputs the selected audio signal to the audio output unit 121.

Also, the image processing circuit 131 selects one of image signals output from the BS reception circuit 109, the CS reception circuit 111, the ground wave reception circuits 113 and 115 and the network processing circuit 117 and combines the image signal with image data according to an instruction from the system control circuit 131, and stores the image signal in the image memory 125.

The display control circuit 127 reads out the image signal thus written to the memory 125, converts the signal into a form suitable for display in the display unit 127, and outputs the converted signal to the display unit 127.

In this state, when the user presses the menu key 701 of the remote controller 139 to display an operation menu, the system control circuit 131 instructs the menu generation circuit 135 to generate a corresponding menu image. Receiving the menu image generation instruction from the system control circuit 131, the menu generation circuit 135 reads out a menu image at the first hierarchical level, i.e., the menu image 201 shown in FIG. 2, and supplies the menu image to the display control circuit 127. At this time, the menu generation circuit 135 outputs menu image data such that a cursor is added to one of the menu items when the menu item is selected, thereby enabling the selected menu item to be easily recognized.

Next, when the user operates the upward movement key 703 or the downward movement key 705 of the remote controller 139, the system control circuit 131 informs the menu generation circuit 135 of this operation. Then the menu generation circuit 135 moves the cursor to an upper or lower item at the same hierarchical level in accordance with the key operation of the upward movement key 703 or the downward movement key 705. FIG. 8 illustrates a state of the display screen of the display unit 129 corresponding to the result of the operation described above. In FIG. 8, the item presently selected (“IMAGE QUALITY” in the example shown in FIG. 8) is indicated by hatching.

And, when the user presses the determination key 707 of the remote controller 139, the system control circuit 131 informs the menu generation circuit 135 of this operation. The menu generation circuit 135 reads out a menu image at the second hierarchical level corresponding to the presently selected item from the menu image storing unit 137, combines it with the menu image at the first hierarchical level, and outputs the combined image to the display control circuit 127. For example, in the case where “IMAGE QUALITY” is selected at the first hierarchical level as shown in FIG. 8, the menu image 301 shown in FIG. 3 is read out from the menu image storing unit 137.

Also at this time, the menu generation circuit 135 adds the cursor to the menu image and outputs the menu image with the cursor to the display control circuit 127, as it does at the first hierarchical level. The user can move the cursor to the desired item at the second hierarchical level by the upward movement key 703 or the downward movement key 705 of the remote controller 139.

The user operates the determination key 707 of the remote controller 139 while, for example, the second item (contrast) in the menu portion 301 at the second hierarchical level shown in FIG. 3 is selected. The system control circuit 131 informs the menu generation circuit 135 of this operation. The menu generation circuit 135 reads out a menu image at the third hierarchical level corresponding to the selected item at the second hierarchical level (e.g., the menu image 401 shown in FIG. 4) from the menu image storing unit 137, combines it with the first- and second-hierarchical-level menu images, and outputs the combined image to the display control circuit 127, as it does in the above-described steps.

Further, the user operates the determination key 707 of the remote controller 139 while, for example, the second item (minus) in the menu image 401 at the third hierarchical level shown in FIG. 4 is selected. The system control circuit 131 informs the menu generation circuit 135 of this operation. The menu generation circuit 135 reads out a menu image at the fourth hierarchical level corresponding to the presently selected second item (e.g., the menu image 501 shown in FIG. 5) from the menu image storing unit 137, combines it with the first-, second- and third-hierarchical-level menu images, and outputs the combined image to the display control circuit 127, as it does in the above-described steps. At this time, the menu generation circuit 135 provides display data such that the cursor is added to the selected item at each of the first to third hierarchical levels.

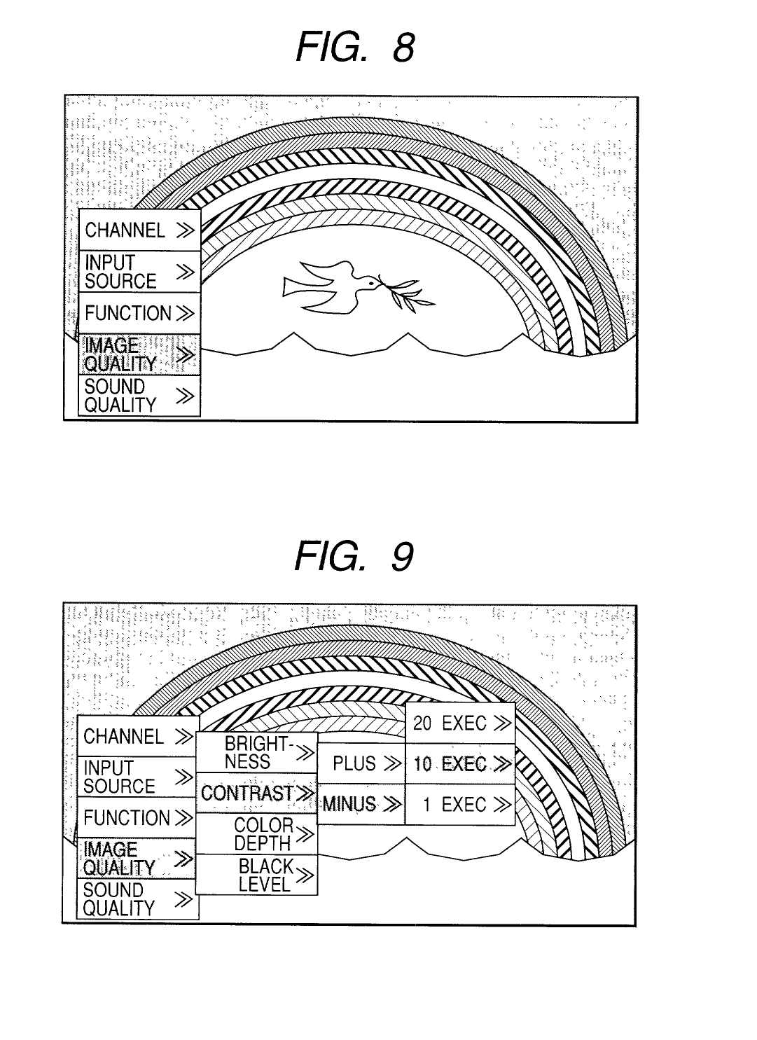

FIG. 9 illustrates a displayed state of first- to fourth-hierarchical-level menu images on the display unit 129 in the case where the user operates the remote controller 139 by the above-described procedure to select “IMAGE QUALITY” at the first hierarchical level, “CONTRAST” at the second hierarchical level and “MINUS” at the third hierarchical level.

When, in the state shown in FIG. 9, the user moves the cursor to a position on the menu item “10 EXEC” at the fourth hierarchical level by operating the upward movement key 703 or the downward movement key 705 of the remote controller 139 and operates the determination key 707 of the remote controller 139, the system control circuit 131 controls each block according to the menu items successively selected and determined by the user since the menu portion at the fourth hierarchical level is the lowest-level menu portion. More specifically, the system control circuit 131 controls the image processing circuit 123 so that the contrast value is changed to a value obtained by subtracting 10 in terms of an internal parameter value from the present set value.

Thus, the user can perform adjustment/change control of the television receiver of this embodiment.

Further, in this embodiment, when one of the items at the fourth hierarchical level, i.e., the lowest hierarchical level displayed is selected and when the determination key 707 is operated, the system control circuit 131 instructs the menu generation circuit 135 to enable display of the registration menu 601 shown in FIG. 6.

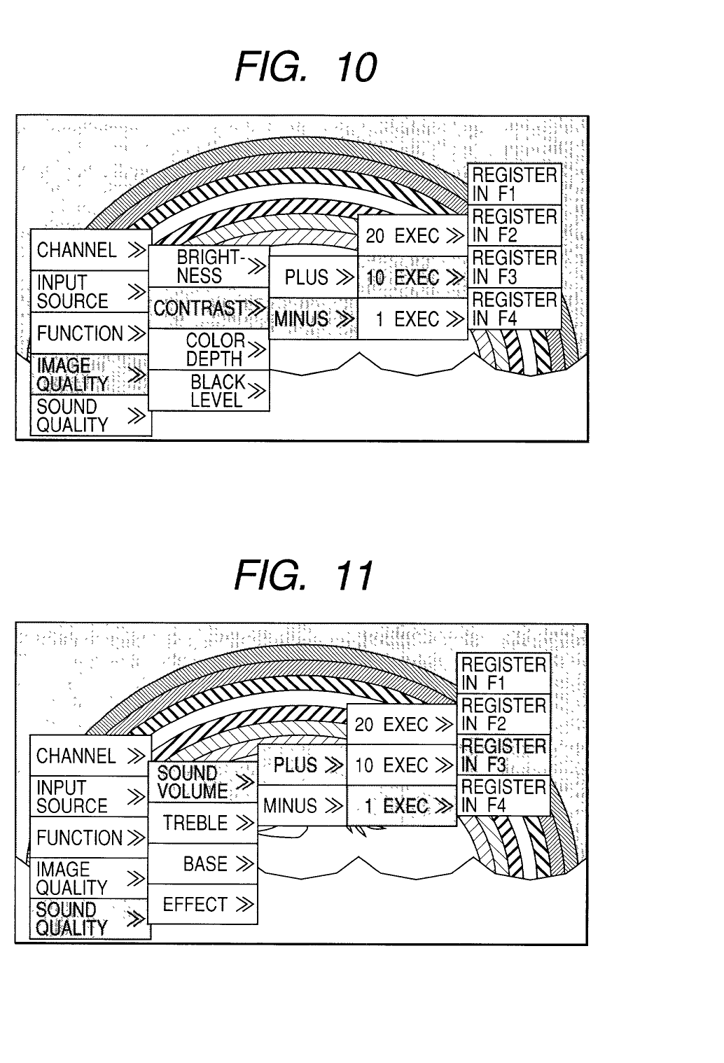

According to this instruction, the menu generation circuit 135 reads out the image data of the registration menu 601 shown in FIG. 6 from the menu image storing unit 137, combines the read image data with the data of the operation menu image that has been displayed as shown in FIG. 9, and outputs the combined data to the display control circuit 127, thereby displaying the registration menu on the display unit 129 in addition to the menu image shown in FIG. 9, as shown in FIG. 10.

In the display shown in FIG. 10, the user can move the cursor upward or downward by operating the upward movement key 703 or the downward movement key 705 of the remote controller 139 to select one of the items from registration in Fl to registration in F4.

For example, as shown in FIG. 11, the user operates the determination key 707 of the remote controller 139 while the third item “REGISTER in F3” is selected. The control items selected by the user in the preceding steps are “SOUND QUALITY” at the first hierarchical level, “SOUND VOLUME” at the second hierarchical level, “PLUS” at the third hierarchical level, and “1 EXEC” at the fourth hierarchical level. Accordingly, the system control circuit 131 stores in an internal memory the function of “changing the set value of the sound volume in sound quality to a value+1 larger than the present set value” by relating it to the F3 key 713. More specifically, the system control circuit 131 stores in the internal memory the key code of the F3 key 713 and processing for “changing the set value of the sound volume in sound quality to a value+1 larger than the present set value” in a linked relationship.

Thereafter, when the user operates the F3 key 713 of the remote controller 139 in the normal state with no operation menu displayed on the display unit 129, the photo-reception unit 133 outputs the key code of the F3 key 713 to the system control circuit 131. The system control circuit 131 supplied with the key code of the F3 key 713 controls each circuit of the television receiver 100 according to the function stored in the internal memory by being related to the F3 key 713. In this example, the system control circuit 131 controls the audio processing circuit 119 so that the sound volume is changed to a value+1 larger than the present set value in terms of an internal processing parameter.

In this embodiment, as described above, the user can assign the desired operating function to a function key by only performing a simple operation for selecting an item corresponding to the function key to which the user wishes to assign the function from the registration menu displayed as a menu at the lowest level, i.e., the level subordinate to the fourth hierarchical level in the process of setting a function in the television receiver 100 through the ordinary hierarchical menu. The user may perform a single operation using the function key with which the control function has been registered to adjust, change and control the television receiver of this embodiment in accordance with the contents of the function previously registered by a simple operation.

An example of a method for storing control items in a linked relationship with the function key 709, 711, 713, or 715 will next be described.

In this method, items at each hierarchical level are numbered in order and each of the numbers at each hierarchical level is expressed by a 4-bit digital signal, for example. In an example shown in FIG. 10, the fourth item (ID=4) at the first hierarchical level, the second item (ID=2) at the second hierarchical level, the second item (ID=2) at the third hierarchical level, and the second item (ID=2) at the fourth hierarchical level are selected and the system control circuit 131 stores code data “4222” representing the processing function at an internal memory (e.g., an EEPROM) address corresponding to a designated function key.

The system control circuit 131 stores the number of the items at each hierarchical level and the corresponding processing functions. When the key code corresponding to one of the function keys is output from the photo-reception unit 133, the system control circuit 131 reads out from the internal memory the data stored by being linked to the function key. If the contents of the registration of the function key in the internal memory are “4222”, the system control circuit 131 controls the image processing circuit 123 so that the contrast value is changed to a value determined by subtracting 10 from the present set value.

Needless to say, in a case where, while the menu image shown in FIG. 11 is being displayed on the display unit 129, the first item (registration in Fl) in the registration menu is selected followed by pressing of the determination key 707, the same function is registered with the Fl function key 709. The registration may be performed in the same manner with respect to the F2 key 711 or the F4 key 715.

When the end key 717 of the remote controller 139 is operated, the system control circuit 131 controls the menu generation circuit 135 so that the menu image is erased and image display in the ordinary mode is performed.

The following three methods are conceivable as a method of selecting a time at which the registration with the function key 709, 711, 713, or 715 is made effective. In the first method, when the end key 717 is operated, the registration operation performed on the menu display before this end key 717 operation becomes effective. In the second method, the registration performed by selecting one of the registration menu items at the lowest layer on the menu display and by operating the determination key 707 becomes effective immediately after the operation of the determination key 707. In the third method, the registration becomes effective after a lapse of a certain time period if no operation is performed after the registration operation.

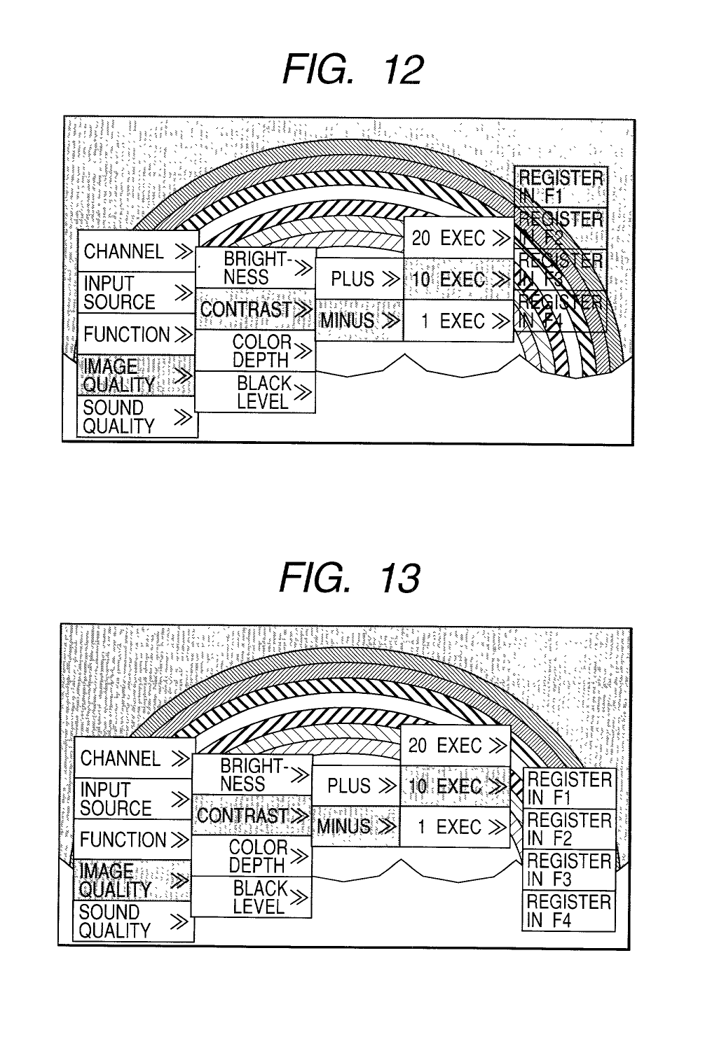

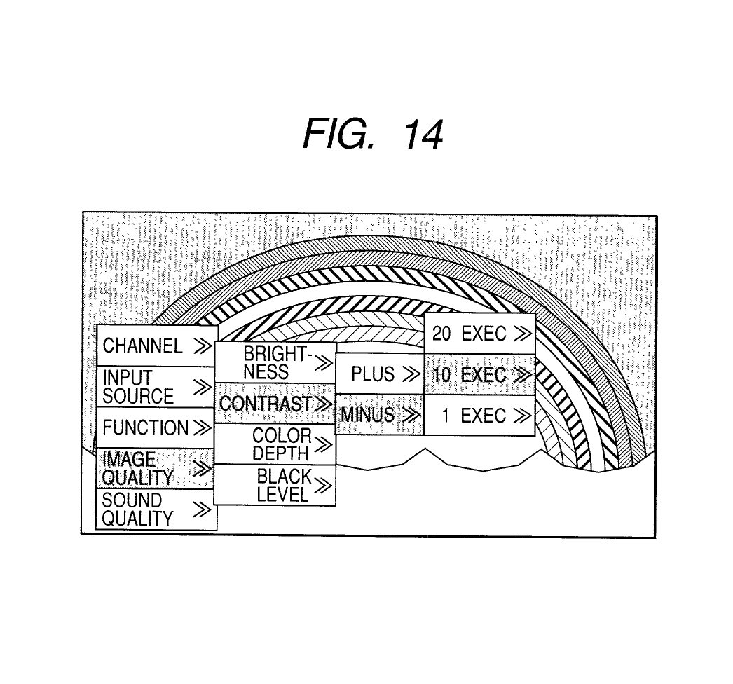

The registration menu may be displayed in a transparent state such that an image behind the menu image can be seen, as shown in FIG. 12. The registration menu can be displayed in this manner to reduce interference with user's viewing.

The arrangement may also be such that if, while the menu image shown in FIG. 9 is displayed on the display unit 129, the user selects one of the menu items at the fourth hierarchical level and presses the determination key 707 of the remote controller 139 for a time period equal to or longer than a predetermined time period, the registration menu may be displayed to enable the user to perform the above-described registration operation. If the user presses the determination key 707 for a time period shorter than the predetermined time period, the menu display process may be terminated without displaying any registration menu.

This method further reduces the amount of user operation and prevents interference of the registration menu with user's viewing.

It is not always necessary to display the registration menu as a menu at the lowest level. For example, the arrangement may be such that if, while the menu image shown in FIG. 9 is displayed on the display unit 129, the user selects one of the menu items at the fourth hierarchical level and presses the determination key 707 for a time period equal to or longer than a predetermined time period, the system control circuit 131 may control the menu generation circuit 135 to display the registration menu on an end portion of the screen separately from the operation menu from the first- to fourth-hierarchical levels, as shown in FIG. 13.

Needless to say, menu images stored as image data in the menu image storing unit 137 may alternatively be character code data. In such a case, there is a need for font data. However, if the television receiver has a browser function, it has font data for the browser function, and this font data may be shared between the browser function and display of menu images.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image processing apparatus, comprising:
image input means for inputting an image signal relating to a television broadcast;
menu generation means for generating a menu image signal representing an operation menu relating to processing of the image signal and having a plurality of menu portions at different hierarchical levels each including at least one menu item;
display control means for displaying on a display unit an image corresponding to the image signal output from said image input means and the operation menu corresponding to the menu image signal generated by said menu generation means;
instruction input means for receiving an instruction from an operating unit including a plurality of function keys and selection means for selecting a desired item in the operation menu displayed on said display unit;
assignment means for assigning, according to a predetermined operation by the operating unit, a function according to one item selected by said selection means from the items in the operation menu displayed on said display unit to one of said plurality of function keys; and
control means for controlling, in response to said operation of the function key, said image input means to execute processing corresponding to the function assigned to said function key by said assignment means.

2. An apparatus according to claim 1, wherein said menu generation means further generates a registration menu image signal representing a registration menu having a plurality of items corresponding to said plurality of function keys, and outputs the registration menu image signal to said display control means.

3. An apparatus according to claim 2, wherein said menu generation means generates said registration menu image signal so that said registration menu is displayed adjacent to said operation menu.

4. An apparatus according to claim 2, wherein said selection means is also capable of selecting one of the items in said registration menu as desired, and said assignment means assigns the function corresponding to the item selected from said operation menu by said selection means to one of the function keys corresponding to the item selected from the registration menu by said selection means.

5. An apparatus according to claim 2, wherein said assignment means performs said assignment operation according to the key operation performed by said operating unit to determine one of the items in said registration menu as desired.

6. An apparatus according to claim 2, wherein said assignment means performs said assignment operation in response to the absence of any operation by said operating unit during a predetermined time period.

7. An apparatus according to claim 1, wherein said menu portion at the lowest level includes a plurality of menu items corresponding to said plurality of function keys, and said assignment means assigns the function corresponding to the item selected from said operation menu by said selection means to one of the function keys corresponding to the item selected from the menu items at the lowest level by said selection means.

8. An apparatus according to claim 1, wherein said control means controls said control object in order to execute the function corresponding to the item selected by said selection means from the operation menu displayed on said display unit.

9. An apparatus according to claim 1, wherein said operating unit comprises a remote control device.

10. An apparatus according to claim 1, wherein said menu generation means includes a storage unit for storing image data representing said operation menu.

11. An apparatus according to claim 1, wherein said menu generation means includes a storage unit for storing character code data and font data representing said operation menu.

12. An apparatus according to claim 1, wherein said assignment means includes a memory for storing code data representing functions assigned to said plurality of function keys.

13. An apparatus according to claim 1, wherein said display control means synthesizes a combined image signal by combining the image signal output from said image input means and the menu image signal generated by said menu generation means, and displays an image corresponding to said combined image signal on the display unit.

14. A signal processing apparatus, comprising:
signal input means for inputting an image signal and an audio signal relating to a television broadcast;
menu generation means for generating a menu image signal representing an operation menu relating to processing of the audio signal and having a plurality of menu portions at different hierarchical levels each including at least one menu item;
audio output means for outputting, to an audio monitor, sound relating to the audio signal output from said signal input means;
display control means for displaying on a display unit an image corresponding to the image signal output from said signal input means and the operation menu corresponding to the menu image signal generated by said menu generation means;
instruction input means for receiving an instruction from an operating unit including a plurality of function keys and selection means for selecting a desired item in the operation menu displayed on said display unit;
assignment means for assigning, according to a predetermined operation by said operating unit, a function corresponding to one item selected by said selection means from the items in operation menu displayed on said display unit to one of said plurality of function keys; and
control means for controlling, in response to the operation of said function key, said audio input means to execute processing corresponding to the function assigned to said function key by said assignment means.

15. A television receiver, comprising:
receiving means for receiving a television broadcast;
image processing means for processing an image signal relating to the television broadcast received by said receiving means;
audio processing means for processing an audio signal relating to the television broadcast received by said receiving means;
a display unit;
a speaker for outputting sound corresponding to the audio signal processed by said audio processing;
menu generation means for generating a menu image signal representing an operation menu having a plurality of menu portions at different hierarchical levels and relating to processing of the image signal and the audio signal;
display control means for synthesizing a combined image signal by combining the image signal output from said image processing means and the menu image signal generated by said menu generation means, and for displaying an image corresponding to the combined image signal on said display unit;
instruction input means for receiving an instruction from a remote controller having an including of function keys and selection means for selecting a desired item in the operation menu displayed on said display unit;
assignment means for assigning, according to a predetermined operation by said remote controller, a function according to one item selected by said selection means from items in the operation menu displayed on said display unit to one of said plurality of function keys; and
control means for controlling, in response to the operation of said function key, said image processing means and said audio processing means to execute processing according to said function assigned to the function key by said assignment means.

16. An image processing method, comprising the steps of:
inputting an image signal relating to a television broadcast;
generating a menu image signal representing an operation menu relating to processing of the image signal and having a plurality of menu portions at different hierarchical levels each including at least one menu item;
displaying on a display unit an image corresponding to the image signal obtained in said signal input step and the operation menu corresponding to the menu image signal generated in said menu generation step;
receiving an instruction from an operating unit including a plurality of function keys and selection means for selecting a desired item in the operation menu displayed on the display unit;
assigning, according to a predetermined operation by the operating unit, a function corresponding to one item selected by said selection means from the items in the operation menu displayed on said display unit to one of the plurality of function keys; and
controlling, in response to said operation of the function key, said signal input step to execute processing according to the function assigned to said function key in said assignment step.

17. A signal processing method, comprising the steps of:
inputting an image signal and an audio signal relating to a television broadcast;
generating a menu image signal representing an operation menu relating to processing of the audio signal and having a plurality of menu portions at different hierarchical levels each including at least one menu item;
outputting, to an audio monitor, sound correspoding to the audio signal obtained in said signal input step;
displaying on a display unit an image corresponding to the image signal obtained in said signal input step and the operation menu corresponding to the menu image signal generated in said menu generation step;
receiving an instruction from an operating unit including a plurality of function keys and selection means for selecting a desired item in the operation menu displayed on the display unit;
assigning, according to a predetermined operation by said operating unit, a function according to one item selected by said selection means from the items in operation menu displayed on said display unit to one of said plurality of function keys; and
controlling, in response to the operation of the function key, said audio input step to execute processing corresponding to the function assigned to said function key in said assignment step.
